(19) United States
(12) Patent Application Publication
(10) Pub. No.: US 2015/0054265 A1
(43) Pub. Date: Feb. 26, 2015

(54) VEHICLE SIDE AIR CURTAIN WITH CONTROLLED PRESSURE CHAMBER

(71) Applicant: Ford Global Technologies, LLC, Dearborn, MI (US)

(72) Inventors: Zhibing Deng, Northville, MI (US); Tahmidur Rahman, Canton, MI (US); Pardeep Kumar Jindal, Canton, MI (US)

(73) Assignee: Ford Global Technologies, LLC, Dearborn, MI (US)

(21) Appl. No.: 13/970,684

(22) Filed: Aug. 20, 2013

(51) Int. Cl. B60R 21/213

(52) U.S. Cl. CPC B60R 21/213
USPC 280/730.2

(57) ABSTRACT

A vehicle side air curtain has an inflator, a main inflatable chamber, and an integral separate, self-contained controlled pressure chamber in limited fluid communication with the main inflatable chamber of the side air curtain and disposed for impact by the head and upper thoracic region of a vehicle occupant. The main inflatable chamber is inflated to an initial pressure within an initial impact time period immediately following actuation of the inflator and a second lower stabilized pressure thereafter to extend the duration of the pressurization of the main inflatable chamber of the side air curtain beyond the initial impact time period. The controlled pressure chamber of the side air curtain is inflated to an initial pressure substantially lower than the first pressure of the main inflatable chamber and favorable to side impact occupant protection immediately following actuation of the inflator pressure.

### FIELD OF THE INVENTION

The present invention generally relates to a side air curtain for a motor vehicle to optimize side impact protection while simultaneously providing occupant ejection mitigation from the vehicle during a vehicle side impact or rollover event, specifically a side air curtain that includes a controlled pressure chamber that provides a variable pressure chamber throughout the course of the impact event.

### BACKGROUND OF THE INVENTION

Side air curtain systems for use in motor vehicles have been adopted to mitigate occupant ejection during motor vehicle side impact or rollover events, and are generally well-known in the art. Traditionally, such side air curtain systems have been used in combination with exterior motor vehicle components to manage and control motor vehicle impact events with external objects and rollover events. In particular, Federal Motor Vehicle Safety Standard (FMVSS) No. 226 has been promulgated to address side impact and rollover events that potentially may result in occupant ejection from the interior of the motor vehicle. In sum, where a side air curtain is employed to mitigate occupant ejection, FMVSS 226 presently requires the side air curtain to maintain pressure for up to 6 seconds after deployment.

Further, side impact airbag systems have been developed to address vehicle intrusion in the event of a side impact pursuant to FMVSS 214 and to provide occupant restraint against occupant collision with interior motor vehicle components, such as the so-called A pillar, B pillar, and interior upper rail assembly. In contrast to side air curtains, however, side airbag systems are designed to deploy very rapidly after detecting the first impact event and stay inflated for only about 100 milliseconds.

Since side air curtain pressure must be sustained over the 6 seconds duration of inflation, the side air curtain initial pressure is typically raised to a level sufficient to provide stiffness in the side air curtain throughout the 6 seconds set forth in the requirements of FMVSS 226. However, higher initial side air curtain pressures have been found to aggravate head impact response criteria upon initial impact. Thus, to comply with both FMVSS 214 and FMVSS 226, a lower initial pressure in the side air curtain is desirable, with a higher sustained pressure provided later in the impact event.

To achieve such a goal, a dual stage inflator can be used. A first stage inflator can be used to pressurize the side air curtain to a first pressure for a limited time after the first impact, with a second stage inflator used to pressurize the side air curtain to a second, higher pressure later in the impact event to mitigate ejection. However, such a dual stage inflator system presents a cost penalty, presents significant packaging challenges, and adds weight to the motor vehicle. Hence, solutions for providing side impact occupant protection while also mitigating occupant ejection during such side impact events would be advantageous.

The vehicle side air curtain disclosed herein particularly accomplishes the foregoing optimization of vehicle performance and provides a cost-efficient approach to address the problem by employing a side air curtain having an integral separate, self-contained controlled pressure chamber in the location required for compliance with FMVSS 214 in limited fluid communication with the remainder of the side air curtain. For a limited period of time, the controlled pressure chamber of the side air curtain experiences an initial pressure favorable to head impact protection during the initial impact time period, while the remainder of the side air curtain experiences a significantly higher initial pressure adapted to optimize the longer duration of the side air curtain pressurization. After the initial impact time period, the pressure differential between the controlled pressure chamber and the remainder of the side air curtain causes the pressure in each of the controlled pressure chamber and the remainder of the side air curtain to equalize at a stabilized pressure that is optimized to sustain a sufficient inflation pressure for the time required for ejection mitigation protection.

### SUMMARY OF THE INVENTION

According to one aspect of the present disclosure, a vehicle side air curtain for a motor vehicle has an inflator, a main inflatable chamber, and an integral separate, self-contained controlled pressure chamber in limited fluid communication with the main inflatable chamber of the side air curtain and disposed for impact by the head and upper thoracic region of a vehicle occupant. The main inflatable chamber of the side air curtain is inflated to an initial pressure substantially immediately following actuation of the inflator and a second lower stabilized pressure thereafter to extend the duration of the pressurization of the main inflatable chamber of the side air curtain beyond the initial impact time period. The controlled pressure chamber of the side air curtain is inflated to an initial pressure substantially lower than the initial pressure of the main inflatable chamber of the side air curtain and to a pressure favorable to side impact occupant protection substantially immediately following actuation of the inflator.

Still another aspect of the present disclosure is a side air curtain where the pressure differential between the main inflatable chamber of the side air curtain and the controlled pressure chamber causes the pressure in the controlled pressure chamber to equalize with the second stabilized pressure in the main inflatable chamber after the initial impact time period, such that the pressure of each of the controlled pressure chamber and the main inflatable chamber of the side air curtain remain at relatively elevated levels thereafter to mitigate occupant ejection.

Yet another aspect of the present disclosure is a side air curtain where the initial pressure in the main inflatable chamber is at least 100 KPa within 30 milliseconds after actuation of the inflator and the second lower stabilized pressure in the main inflatable chamber is about 80 KPa within 100 milliseconds after actuation of the inflator.

An additional aspect of the present disclosure is a side air curtain where the initial pressure of the controlled pressure chamber of the side air curtain is less than 20 KPa within 30 milliseconds after actuation of the inflator and the pressure of the controlled pressure chamber of the side air curtain is about 80 KPa within 100 milliseconds after actuation of the inflator.

Another aspect of the present disclosure is a side air curtain where the pressure in each of the main inflatable chamber and the controlled pressure chamber is about 80 KPa at 100 milliseconds, which maintains sufficient pressure level in both for at least 6 seconds for ejection mitigation.

An additional aspect of the present disclosure is a side air curtain mounted on the upper side rail assembly of the motor vehicle.

A further aspect of the present disclosure is a side air curtain where the main inflatable chamber is in fluid communication with the controlled chamber via a gas vent that regulates the rate of fluid flow between the main inflatable chamber and the controlled pressure chamber.

Yet a further aspect of the present disclosure is a side air curtain where the main inflatable chamber is in fluid communication with the controlled pressure chamber via a plurality of gas vents.

An additional aspect of the present disclosure is a side air curtain where the main inflatable chamber comprises a plurality of interconnected cavities in fluid communication one to the other about their peripheries to form a substantially flat side panel to prevent occupant ejection and the controlled pressure chamber is disposed within the plurality of the cavities.

Yet another aspect of the present disclosure is a side air curtain where the controlled pressure chamber is disposed proximate the head and upper thoracic region of a vehicle occupant when deployed.

A still further aspect of the present disclosure is a side air curtain where the main inflatable chamber comprises a non-inflated vent panel that is interconnected about its periphery to the plurality of cavities.

Another aspect of the present disclosure is a side air curtain where the main inflatable chamber comprises a non-inflated vent panel disposed longitudinally proximate the middle of the flat panel and the controlled pressure chamber is disposed longitudinally forward on the flat panel and proximate the head and upper thoracic region of a vehicle occupant when deployed.

A yet additional aspect of the present disclosure is a side air curtain comprising an inflator, a main chamber, and an impact chamber in limited fluid communication with the main chamber, wherein the main chamber is inflated to a first pressure immediately after actuation of the inflator and a second pressure thereafter, and the impact chamber is inflated to a pressure substantially lower than the first pressure of the main chamber immediately after actuation of the inflator.

A further aspect of the present disclosure is a method of mitigating occupant ejection and occupant injury, the method comprising the steps of providing a vehicle side air curtain having an inflator, a main inflatable chamber, and an integral separate controlled, self-contained pressure chamber in limited fluid communication with the main inflatable chamber of the side air curtain and disposed for impact by the head and upper thoracic region of a vehicle occupant, inflating the main inflatable chamber of the side air curtain in response to a side impact or rollover event to an initial pressure substantially immediately following actuation of the inflator and a second lower stabilized pressure thereafter to extend the duration of the pressurization of the main inflatable chamber of the side air curtain beyond the initial impact time period, inflating the controlled pressure chamber of the side air curtain to an initial pressure favorable to side impact occupant protection and substantially lower than the initial pressure of the main inflatable chamber of the side air curtain substantially immediately following actuation of the inflator, and equalizing the pressure differential between the main inflatable chamber of the side air curtain and the controlled pressure chamber after the initial impact time period to the second lower stabilized pressure, such that the pressure of each of the controlled pressure chamber and the main inflatable chamber of the side air curtain remain at elevated levels to mitigate occupant ejection.

Still another aspect of the present disclosure is a method of mitigating occupant ejection and occupant injury where the initial pressure in the main inflatable chamber is at least 100 KPa within 30 milliseconds after actuation of the inflator and the second stabilized pressure in each of the main inflatable chamber and the controlled pressure chamber is about 80 KPa within 100 milliseconds after actuation of the inflator.

Yet another aspect of the present disclosure is a method of mitigating occupant ejection and occupant injury where the initial pressure of the controlled pressure chamber of the side air curtain is less than 20 KPa within 30 milliseconds after actuation of the inflator and the second stabilized pressure in each of main inflatable chamber and the controlled pressure chamber is about 80 KPa within 100 milliseconds after actuation of the inflator.

These and other aspects, objects, and features of the present disclosure will be understood and appreciated by those skilled in the art upon studying the following specification, claims, and appended drawings.

### BRIEF DESCRIPTION OF THE DRAWINGS

In the drawings:

FIG. 1 is a side perspective view of the interior of a motor vehicle incorporating the vehicle side air curtain with a controlled pressure chamber in accordance with the present disclosure in the inflated condition;

FIG. 2A is a front side perspective view of a typical vehicle side air curtain without a controlled pressure chamber in the partially inflated condition 20 milliseconds after deployment;

FIG. 2B is a front side perspective view of a typical vehicle side air curtain without a controlled pressure chamber in the fully inflated condition 50 milliseconds after deployment;

FIG. 3A is a front side perspective view of a vehicle side air curtain with a controlled pressure chamber in accordance with the present disclosure, where the main side air curtain is in the fully inflated condition and the controlled pressure chamber is in the semi-inflated condition 20 milliseconds after deployment;

FIG. 3B is a front side perspective view of a vehicle side air curtain with a controlled pressure chamber in accordance with the present disclosure, where the main side air curtain is in the fully inflated condition and the controlled pressure chamber is in the fully inflated condition 50 milliseconds after deployment;

FIG. 4 is a rear top side perspective view of the controlled pressure chamber integrated in the main side air curtain in accordance with the present disclosure;

FIG. 5 is a rear top side perspective view of the interior of the bottom of one of the cavities of the main side air curtain and the gas inlets on a transition panel between the controlled pressure chamber and the main side air curtain in accordance with the present disclosure; and

FIG. 6 is a graphical representation of the pressures within the main inflation chamber and the controllable pressure chamber in the initial period of inflation of the side air curtain of the present disclosure.

### DETAILED DESCRIPTION OF THE PREFERRED EMBODIMENTS

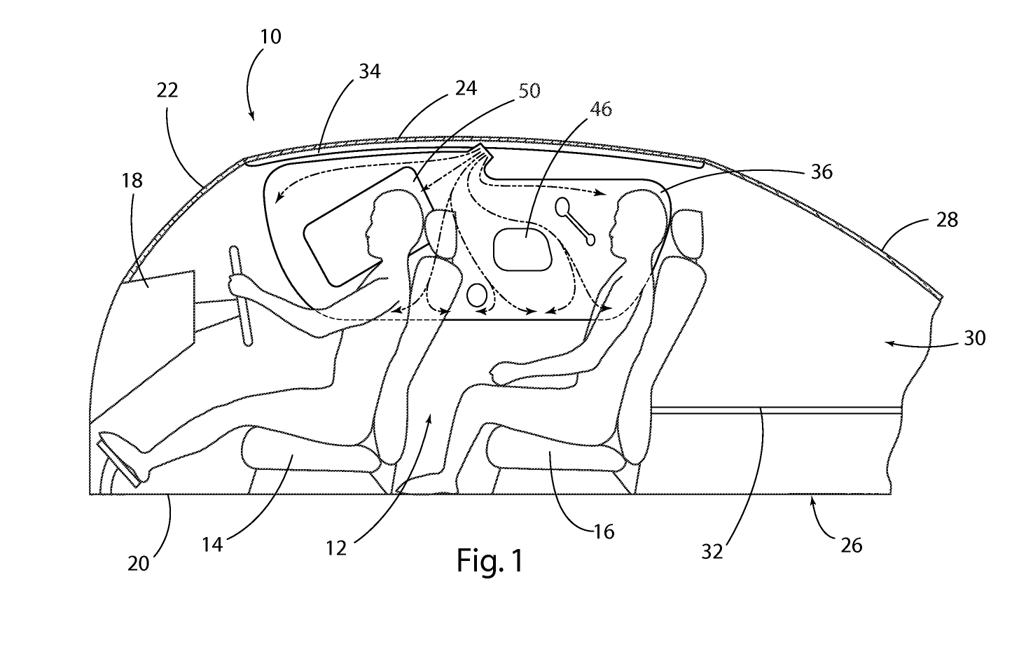

For purposes of description herein, the terms “upper,” “lower,” “right,” “left,” “rear,” “front,” “vertical,” “horizontal,” and derivatives thereof shall relate to the invention as oriented in FIG. 1. However, it is to be understood that the invention may assume various alternative orientations and step sequences, except where expressly specified to the contrary. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

Referring to FIG. 1, a motor vehicle 10 includes an interior occupant compartment 12 including a front seat assembly 14, a rear seat assembly 16, and a dashboard 18, the occupant compartment 12 defined substantially by a floor 20, windshield 22, and a roof portion 24. As is conventional, the rear end 26 of the motor vehicle 10 comprises a rear backlight 28, such as that installed in a hatchback that may be selectively opened to allow access to a cargo area 30 situated above a cargo floor 32. Of course, the motor vehicle 10 can employ a traditional trunk and truck lid assembly behind a rear window to enclosed the cargo area 30. As shown in FIG. 1, the roof portion 24 includes an upper side rail assembly 34 to which may be mounted the side air curtain 36 in accordance with the present disclosure.

As shown, the side air curtain 36 when deployed extends forward to the windshield 22 and rearward to the hatchback 28 and sufficiently downwardly so as to essentially obscure the front and rear side window assemblies (not shown). The side air curtain 36 is thus able to mitigate occupant ejection during a side impact event. As noted above, FMVSS 226 requires that the side air curtain 36, if employed, maintains a sufficient pressure to mitigate ejection for a period of 6 seconds after impact and deployment.

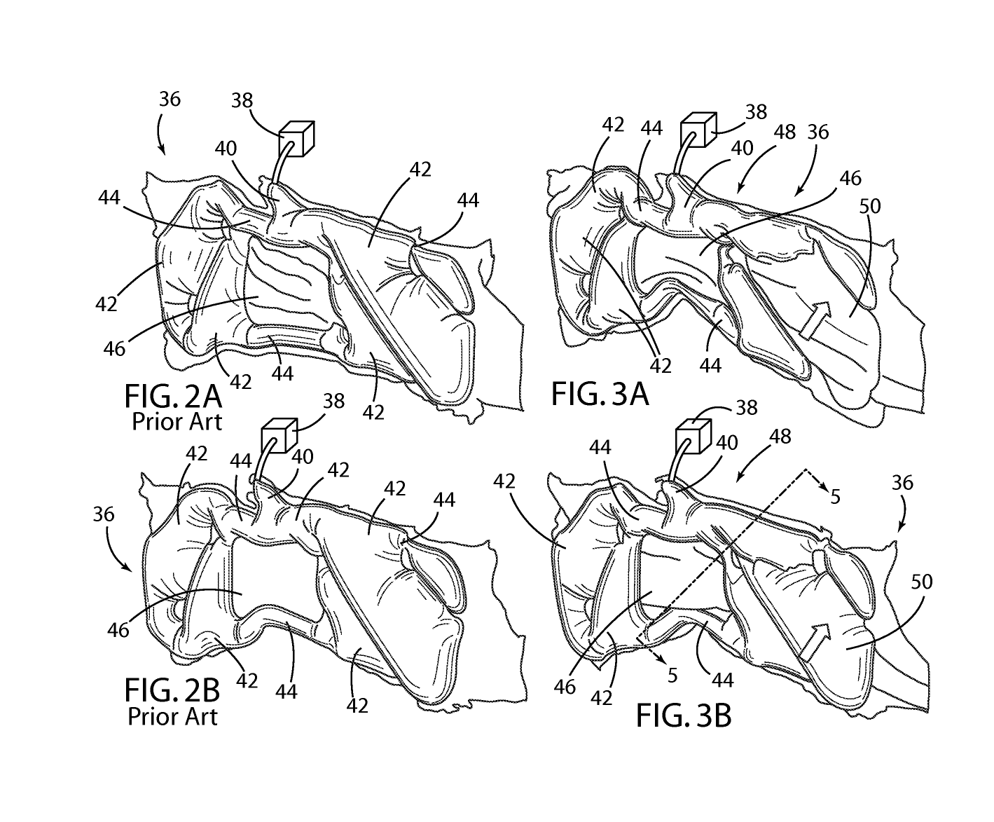

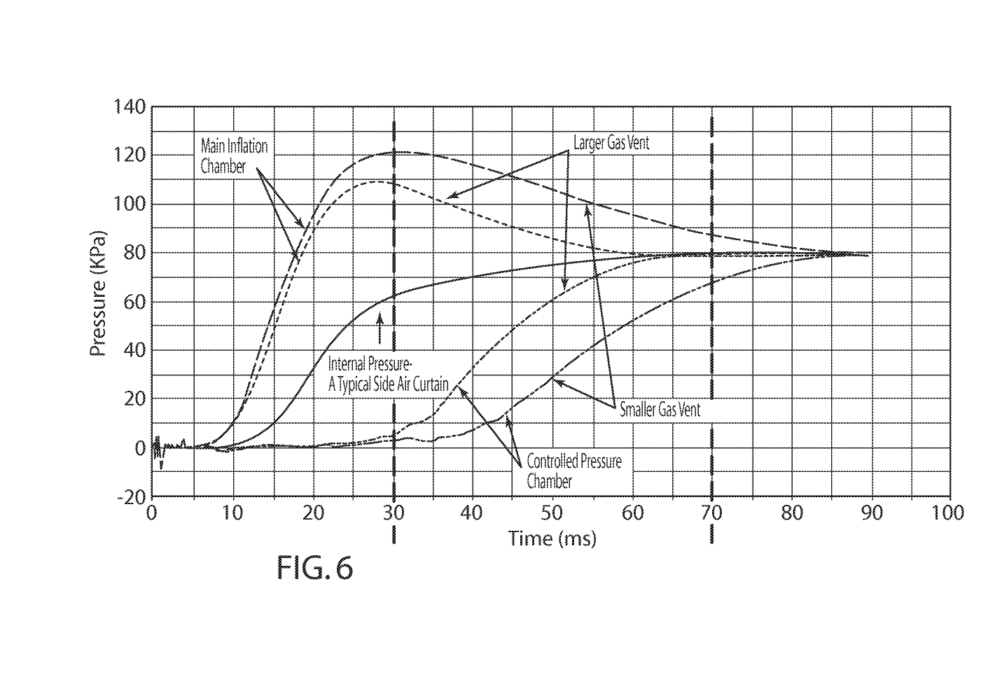

A standard side air curtain 36, without the improvement disclosed herein, is shown in FIGS. 2A-2B. Such a side air curtain 36 is commonly mounted on the interior on both sides of the motor vehicle 10 at the upper side rail assembly 34. Preferably, a sensor (not shown) is used to send a signal to an electronic control unit to actuate an inflator 38 and initiate inflation of the side air curtain 36 through duct 40 upon impact with a side external body or a rollover event, preferably within 5 to 10 milliseconds after the impact event begins. As shown in FIG. 6, the typical inflation profile for a standard side air curtain 36 is an initial pressurization of less than 20 KPa about 10 milliseconds after inflation initiation, with an abrupt rise in pressure to about 60 KPa about 30 milliseconds after inflation initiation. As shown in FIG. 2A, the side air curtain 36 is typically inflated to 30 KPa after about 20 milliseconds after inflation initiation. As shown in FIG. 2B, the pressure in the side air curtain 36 is about 75 KPa about 50 milliseconds after inflation initiation. A final pressure of about 80 KPa is reached about 60 to 70 milliseconds after inflation, which allows maintaining sufficient pressure level for at least 6 seconds to mitigate occupant ejection.

As can be seen in FIGS. 2A-2B, the side air curtain 36 includes a plurality of inflatable cavities 42 that are interconnected one to the other about their peripheries and are in fluid communication one to the other via passages 44. A center portion of the side air curtain 36 is preferably provided with a flat and non-inflatable panel 46 that is designed to provide an ejection barrier, but save the time and gas necessary to positively inflate the side air curtain 36 when deployed.

Further, when a side impact or rollover event occurs, the occupant tends to move toward the vehicle side structure by inertia. However, instead of impacting the A pillar, B pillar, or upper rail of the roof assembly, the occupant's head and upper thoracic region preferably impacts a side impact airbag that is designed to optimize impacts from the head and/or thoracic regions of the vehicle occupant by being inflated to a relatively soft structure. The de-acceleration experienced by the occupant's head is thus reduced. Preferably, the region impacted by an occupant's head and upper thoracic region is less than 20 KPa at about 30 milliseconds after inflation initiation.

As noted above, however, the relative stiffness of the standard side air curtain 36 renders optimization of a relatively soft impact surface desired for alleviation of side impacts under FMVSS 214 difficult. That is, the pressure within the standard side air curtain 36 at a time period 30 milliseconds after inflation initiation, when contact of the head and thoracic region of the occupant typically occurs, is typically about 60 KPa, even though it is desirable that the region near the vehicle occupant's head and thoracic region of the side air curtain be at a pressure of less than 20 KPa at 30 milliseconds after actuation of the inflator.

The side air curtain incorporating the improvement disclosed herein is shown in FIGS. 3A-3B. As can be seen, the side air curtain 36 forms a relatively flat panel that includes a main inflatable chamber 48 and a separate controlled pressure chamber 50. The controlled pressure chamber 50 is disposed forward on the flat panel of the side air curtain 36 so that it is adjacent the vehicle occupant situated in the front seat. That is, the controlled pressure chamber 50 is located forward on the side air curtain 36 relative to the vehicle and proximate the front occupant's head and upper thoracic region.

As shown in FIG. 3A, at 20 milliseconds after deployment or ignition of the inflator 38, the main inflatable chamber 48 of the side air curtain 36 is nearly fully inflated to about 90 KPa, but, as shown, the controlled pressure chamber 50 remains slightly underinflated at 2-3 KPa. In the preferred embodiments, after 30 milliseconds, the pressure in the main inflatable chamber 48 of the side air curtain 36 is overinflated to between 100 and 120 KPa. In contrast, the pressure within the controlled pressure chamber 50 after about 30 milliseconds is at a much lower pressure, preferably less than 20 KPa, and more preferably less than 5 KPa. Thus, the controlled pressure chamber 50 is situated and pressurized to provide the greatest opportunity for mitigation of occupant injuries from a side impact event, while the possibility of subsequent occupant ejection is also reduced.

FIG. 3B shows the side air curtain 36 including the present main inflation chamber of the disclosure 50 milliseconds after inflation initiation. As shown, the pressure in the side air curtain 36 has preferably reduced to between 85 and 110 KPa. The pressure in the controlled pressure chamber 50, however, has been increased in the 20 millisecond interval to preferably between 30 and 60 KPa, depending on pressure regulation, discussed below. In one embodiment, after a period of approximately 65 milliseconds, the pressure in the main chamber of the side air curtain and the controlled pressure chamber 50 becomes equalized at preferably approximately 80 KPa and stays inflated at that pressure for at least 6 seconds, in compliance with FMVSS 226. In another embodiment, the pressure can be equalized at approximately 85 milliseconds at about 80 KPa.

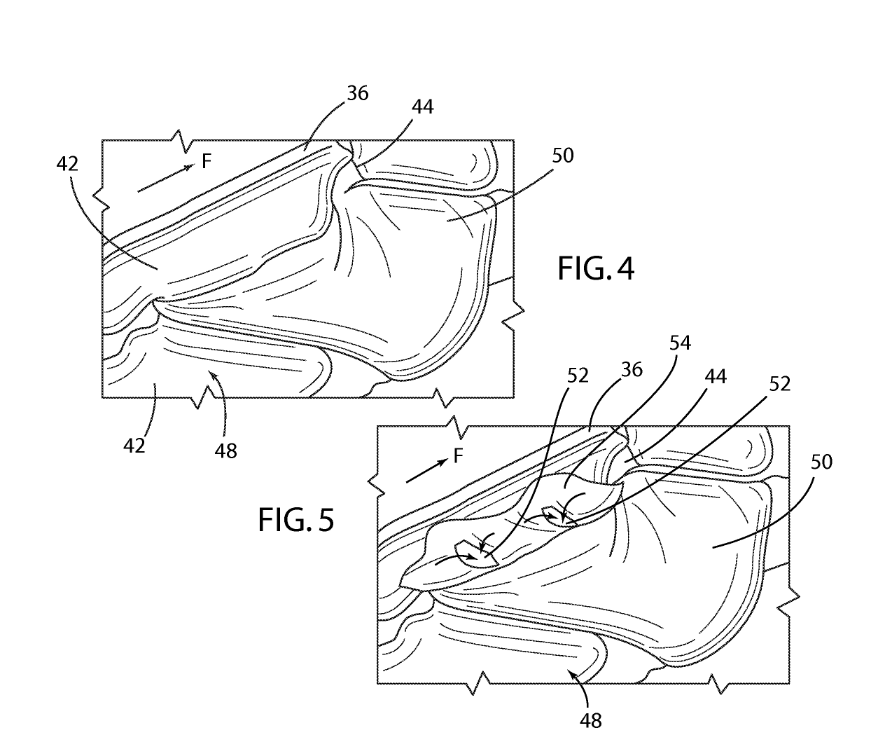

FIGS. 4 and 5 show the controlled pressure chamber 50, which is formed as a single integral separate chamber relative the main inflation chamber 48 of the side air curtain 36. It is comprised of two opposite sheets layers of a flexible air tight material, such as nylon or polyester, as is the remainder of the side air curtain 36, and is fabricated by either stitching or heat welding about its periphery. The controlled pressure chamber 50 is provided with gaseous fluid from the inflator 38 that is delivered to the main chamber 48 and then allowed to pass through one or more vents 52 provided in a transition panel 54 situated between the main inflation chamber 48 and the controlled pressure chamber 50. FIG. 5 shows the controlled pressure chamber 50 with the outer sheet of a portion of the main inflation chamber 48 adjacent the controlled pressure chamber 50 removed to illustrate a pair of gas vents 52 that allow gas to flow from the main inflation chamber 48 into the controlled pressure chamber 50.

The rate of inflation of the controlled pressure chamber 50 from main chamber 48 can be controlled through the size, number, and disposition of the gas vent 52 provided between the two chambers in the transition panel 54. That is, where a larger gas vent 52 is provided or where a plurality of gas vents 52 are provided to create a relatively large combined cross-sectional area, a higher initial pressure within the controlled pressure chamber 50, with relatively lower peak gas pressure in the main inflation chamber 48, will be experienced, as depicted in FIG. 6. However, in the event that lower initial pressures are desired in the controlled pressure chamber 50, smaller gas vents 52 or fewer gas vents 52 can be used. Thus, the pressure in the controlled pressure chamber 50 can be adjusted accordingly, so long as the pressure in the controlled pressure chamber 50 is only allowed to a relatively low initial pressure, preferably less than 20 KPa, and more preferably less than 5 KPa.

Further, the time for pressure equalization can be regulated. For example, as noted above, in a first embodiment of the vent, as shown in FIG. 6, a pair of vents 52, each having a diameter of about 25 millimeters for a larger combined cross-sectional area of about 980 square millimeters can provide pressures that are equalized at approximately 65 milliseconds after inflation initiation to a pressure of about 80 KPa, with pressures in the main inflation chamber 48 of about 110 KPa and the controlled pressure chamber 50 of less than 20 KPa at 30 milliseconds after inflation initiation. In a second embodiment, using a pair of vents 52 each having a diameter of 20 millimeters, for a smaller overall cross-sectional area of about 625 square millimeters, the stabilization time can be extended to roughly 85 milliseconds. With the smaller combined cross-sectional area, pressures may reach about 120 KPa in the main inflation chamber 48 and less than 5 KPa in the controlled pressure chamber 50 at 30 milliseconds after inflation initiation.

Thus, it can be readily contemplated that the performance of the controlled pressure chamber 50 to provide side impact protection under FMVSS 214 can be adjusted to provide optimal performance by controlling the size and number of the vents 52 in the transition panel 54 provided between the main inflation chamber 48 and the controlled pressure chamber 50 of the side air curtain 36. Preferably, the vent 52 provides for the main inflation chamber 48 to experience a pressure of at least 110 KPa within 30 milliseconds after actuation of the inflator 38 and approximately 80 KPa within 100 milliseconds after actuation of the inflator 38. Similarly, the air pressure in the controlled pressure chamber 50 is preferably less than 20 KPa within 30 milliseconds after actuation of the inflator 38, and more preferably less than 5 KPa, but approximately 80 KPa within 100 milliseconds after actuation of the inflator 38.

In accordance with the foregoing disclosure, the need for a second inflator to provide a higher inflation pressure to the main inflation chamber 48 of the side air curtain 36 can be avoided, while simultaneously providing the necessary relative softness to the controlled pressure chamber 50 as the side impact portion of the side air curtain 36 so as to optimize the side impact crash criteria.

It is to be understood that variations and modifications can be made on the aforementioned structure without departing from the concepts of the present invention, and further it is to be understood that such concepts are intended to be covered by the following claims unless these claims by their language expressly state otherwise.

1. A vehicle side air curtain for a motor vehicle, the side air curtain having an inflator, a main inflatable chamber, and an integral separate, self-contained controlled pressure chamber in limited fluid communication with the main inflatable chamber of the side air curtain and disposed laterally in line with and sized to laterally restrain the head and upper thoracic region of a vehicle occupant, wherein the main inflatable chamber of the side air curtain is inflated to an initial pressure within an initial impact time period immediately following actuation of the inflator and a second lower stabilized pressure thereafter to extend the duration of the pressurization of the main inflatable chamber of the side air curtain beyond the initial impact time period, and the controlled pressure chamber of the side air curtain is inflated to an initial pressure substantially lower than the initial pressure of the main inflatable chamber of the side air curtain and a second higher stabilized pressure beyond the initial impact time period, the initial pressure in the controlled pressure chamber being favorable to side impact occupant protection substantially immediately following actuation of the inflator and wherein the head and/or upper thoracic region of the vehicle occupant contacts the controlled pressure chamber when deployed.

2. The side air curtain of claim 1, wherein the initial pressure differential between the main inflatable chamber of the side air curtain and the controlled pressure chamber causes the pressure in the controlled pressure chamber to equalize with the second stabilized pressure in the main inflatable chamber after the initial impact time period, such that the pressure of each of the controlled pressure chamber and the main inflatable chamber of the side air curtain remain at relatively elevated levels thereafter to mitigate occupant ejection.

3. The side air curtain of claim 1, wherein the initial pressure in the main inflatable chamber and the initial pressure of the controlled pressure chamber of the side air curtain occur within 30 milliseconds after actuation of the inflator and the second lower stabilized pressure in the main inflatable chamber and the second higher stabilized pressure in the controlled pressure chamber occur within 100 milliseconds after actuation of the inflator.

4. The side air curtain of claim 3, wherein the initial pressure in the main inflatable chamber is at least 100 KPa, the initial pressure of the controlled pressure chamber of the side air curtain is less than 20 KPa and the second stabilized pressure of each of the main inflatable chamber and the controlled pressure chamber is 80 KPa.

5. The side air curtain of claim 1, wherein the pressure in the main inflatable chamber and the controlled pressure chamber is 80 KPa after at least 100 millisecond following actuation of the inflator to maintain an elevated pressure level in the main inflatable chamber for at least 6 seconds to mitigate ejection mitigation.

6. The side air curtain of claim 1, wherein the motor vehicle comprises an upper side rail assembly and the side air curtain is mounted on the upper side rail assembly.

7. The side air curtain of claim 1, wherein the main inflatable chamber is in fluid communication with the controlled chamber via a gas vent that regulates the rate of fluid flow between the main inflatable chamber and the controlled pressure chamber.

8. The side air curtain of claim 7, wherein the main inflatable chamber is in fluid communication with the controlled pressure chamber via a plurality of gas vents.

9. The side air curtain of claim 7, wherein the main inflatable chamber comprises a plurality of interconnected cavities in fluid communication one to the other about their peripheries to form a substantially flat side panel to prevent occupant ejection and the controlled pressure chamber is disposed proximate one of the plurality of the cavities.

10. The side air curtain of claim 7, wherein the gas vent between the controlled pressure chamber and the main inflatable chamber has a total cross-sectional area of at least 625 square millimeters.

11. The side air curtain of claim 9, wherein the side air curtain comprises a non-inflated panel that is interconnected about its periphery to the plurality of cavities.

12. The side air curtain of claim 9, wherein the side air curtain comprises a non-inflated panel disposed longitudinally proximate the middle of the flat panel and the controlled pressure chamber is disposed longitudinally forward on the flat panel and proximate the head and upper thoracic region of a vehicle occupant when deployed.

13. A vehicle side air curtain comprising an inflator, a main chamber, and an impact chamber in limited fluid communication with the main chamber, wherein the main chamber comprises a plurality of interconnected cavities in fluid communication one to the other about their peripheries that form a substantially flat side panel to prevent occupant ejection and is inflated to a first pressure immediately after actuation of the inflator and a second pressure thereafter, and the impact chamber is disposed proximate one of the plurality of the cavities laterally in line with and sized to laterally restrain the head and upper thoracic region of a vehicle occupant when deployed and is inflated to a first pressure substantially lower than the first pressure of the main chamber immediately after actuation of the inflator, and wherein the head and/or upper thoracic region of the vehicle occupant contacts the impact chamber when deployed.

14. (canceled)

15. The side air curtain of claim 13, wherein the side air curtain comprises a non-inflated panel that is interconnected about its periphery to the cavities.

16. The side air curtain of claim 13, wherein the first pressure in the main chamber and the first pressure of the impact chamber of the side air curtain occur within 30 milliseconds after actuation of the inflator and the second pressure in the main chamber occurs within 100 milliseconds after actuation of the inflator.

17. The side air curtain of claim 13, wherein the first pressure of the impact chamber of the side air curtain is less than 20 KPa and the second pressure in the impact chamber is 80 KPa.

18. A method of mitigating occupant ejection and occupant injury, the method comprising the steps of:
providing a vehicle side air curtain having an inflator, a main inflatable chamber, and an integral separate, self-contained controlled pressure chamber in limited fluid communication with the main inflatable chamber of the side air curtain and disposed for impact by the head and upper thoracic region of a vehicle occupant;
inflating the main inflatable chamber of the side air curtain in response to a side impact or rollover event to an initial pressure substantially within an initial impact time period immediately following actuation of the inflator and a second lower stabilized pressure thereafter to extend the duration of the pressurization of the main inflatable chamber of the side air curtain beyond the initial impact time period;
inflating the controlled pressure chamber of the side air curtain to an initial pressure favorable to side impact occupant protection and substantially lower than the initial pressure of the main inflatable chamber of the side air curtain substantially immediately following actuation of the inflator; and
equalizing the pressure differential between the main inflatable chamber of the side air curtain and the controlled pressure chamber after the initial impact time period to the second lower stabilized pressure of the main inflatable chamber, such that the pressure of each of the controlled pressure chamber and the main inflatable chamber of the side air curtain remain at elevated levels to mitigate occupant ejection.

19. The method of claim 18, wherein the initial pressure in the main inflatable chamber and the initial pressure of the controlled pressure chamber occur within 30 milliseconds after actuation of the inflator and the second stabilized pressure in each of the main inflatable chamber and the controlled pressure chamber occur within 100 milliseconds after actuation of the inflator.

20. The method of claim 18, wherein the initial pressure of the controlled pressure chamber of the side air curtain is less than 20 KPa and the second stabilized pressure in each of main inflatable chamber and the controlled pressure chamber is about 80 KPa.
